(19) United States
(12) Patent Application Publication
(10) Pub. No.: US 2014/0367375 A1
(43) Pub. Date: Dec. 18, 2014

(54) METHOD OF FABRICATING A SOLDER PARTICLE

(71) Applicant: Electronics and Telecommunications Research Institute, Daejeon (KR)

(72) Inventors: Hyun-cheol BAE, Daejeon (KR); Yong Sung EOM, Daejeon (KR); KWANG-SEONG CHOI, Daejeon (KR); Haksun LEE, Daejeon (KR)

(73) Assignee: Electronics and Telecommunications Research Institute, Daejeon (KR)

(21) Appl. No.: 14/089,442

(22) Filed: Nov. 25, 2013

(30) Foreign Application Priority Data
Jun. 18, 2013 (KR) 10-2013-0069728

(51) Int. Cl. H05B 6/00

(52) U.S. Cl. CPC H05B 6/00
USPC 219/635

(57) ABSTRACT

Provided is a method of fabricating a solder particle including adding a first magnetic bar in a first container including a mixture containing first solder particles formed through a mixing process, disposing the first container in a second container including a second magnetic bar, operating the first magnetic bar and the second magnetic bar, and applying heat to the first container to melt the first solder particles.

### CROSS-REFERENCE TO RELATED APPLICATIONS

This U.S. non-provisional patent application claims priority under 35 U.S.C. §119 of Korean Patent Application No. 10-2013-0069728, filed on Jun. 18, 2013, the entire contents of which are hereby incorporated by reference.

### BACKGROUND

The present disclosure herein relates to a method of fabricating a solder particle, and more particularly, to a method of fabricating a solder particle having a diameter of submicrometer or a few micrometers.

According to the miniaturization of mobile communication devices, researches on decreasing the size and integration of chips are actively conducted.

To integrate of a chip, a fine pitch patterned substrate is used. Conventionally, a semiconductor process using a photolithography process was used for forming a solder bump on a metal pad on the fine pitch patterned substrate, or a method of screen printing a solder paste on a substrate and reflowing was used. The semiconductor process is expensive, and the formation of the solder bump having about 150 μm or less pitch is difficult to form by the screen printing process.

Generally, a solder bump is formed on a metal pad on a substrate. In this case, the diameter of solder particle is submicrometer or a few micrometers. The metal pad on which the bump is formed has the size of a few micrometers. A method of using ultrasonic waves is well known for the fabrication of a solder particle having the diameter of submicrometer or a few micrometers. However, the fabricated solder particle having the diameter of submicrometer or a few micrometers may be exposed to the atmosphere, and the oxide layer at the surface may be increased. When the oxide layer is increased, solder binding properties may be deteriorated.

### SUMMARY

The present disclosure provides a method of fabricating a solder particle having the diameter of submicrometer or a few micrometers, by which an oxide layer is not formed on the surface of the solder particle.

The present disclosure is not limited to the above-described aspect, and another aspect will be clearly understood by a person skilled in the art from the following description.

Embodiments of the inventive concept provide a method of fabricating a solder particle including adding a first magnetic bar in a first container including a mixture containing first solder particles formed through a mixing process, disposing the first container in a second container including a second magnetic bar, operating the first magnetic bar and the second magnetic bar, and applying heat to the first container to melt the first solder particles.

In some embodiments, the mixing process may be conducted by mixing the first solder particles with a one-component polymer resin to obtain the mixture.

In other embodiments, the first solder particles may be completely impregnated into the one-component polymer resin.

In still other embodiments, silicon oil may be included in the second container.

In even other embodiments, the melting of the first solder particles may be conducted by heating the silicon oil in the second container, thereby applying heat to the first container by a temperature of the silicon oil.

In yet other embodiments, a temperature of the mixture may be maintained uniformly by the first magnetic bar and the second magnetic bar.

In further embodiments, the first solder particles may be melted at from about 80° C. to about 250° C.

In still further embodiments, the first solder particles may have a diameter of from about 10 μm to about 1,000 μm.

In even further embodiments, the one-component polymer resin may include an epoxy resin or oil.

In yet further embodiments, the epoxy resin may include diglycidyl ether of bisphenol-A (DGEBA), tetraglycidyl-4,4-diaminodiphenylmethane (TGDDM), diglycidyl ether of para-aminophenol (TriGDDM), or Isocyanate group, or a Bismaleimide resin.

In much further embodiments, the oil may be epoxy modified silicone oil, amine modified silicone oil, carboxyl modified silicone oil, or a polyol resin.

In still much further embodiments, the first solder particles may be mixed by from about 1 to about 60 parts by volume with respect to 100 parts by volume of the one-component polymer resin in the mixture.

In even much further embodiments, the first container may have a round edge portion.

In yet much further embodiments, the method may further include conducting an ultrasonic wave process for forming second solder particles by applying ultrasonic wave to the mixture while operating the first magnetic bar and the second magnetic bar, and conducting a cooling process for cooling the mixture including the second solder particles while operating the first magnetic bar and the second magnetic bar after conducting the ultrasonic wave process.

The second solder particles may have a diameter of from about 0.1 μm to less than about 10 μm.

The method of fabricating a solder particle according to an embodiment of the inventive concept includes a melting process. In the melting process, a first magnetic bar and a second magnetic bar are used, and the coagulation of first solder particles during melting the first solder particles may be prevented.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a flowchart illustrating a method of fabricating a solder particle according to an embodiment of the inventive concept;

FIG. 2 is a flowchart illustrating a melting process according to an embodiment of the inventive concept;

FIGS. 3A to 3C are cross-sectional views illustrating a method of fabricating a solder particle according to an embodiment of the inventive concept; and

FIG. 4 is a graph illustrating the particle size of solder particles obtained by a method of fabricating a solder particle according to an embodiment of the inventive concept.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Like reference numerals refer to like elements throughout.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations and/or planar illustrations that are schematic illustrations of idealized example embodiments. In the drawings, the dimensions of layers and regions are exaggerated for clarity of illustration. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, a region illustrated as a rectangle will, typically, have rounded or curved features. Thus, the regions illustrated in the figures are schematic in nature and their shapes are not intended to illustrate the actual shape of a region of a device and are not intended to limit the scope of the present inventive concept.

Hereinafter, exemplary embodiments of the inventive concept will be described in detail with reference to the accompanying drawings.

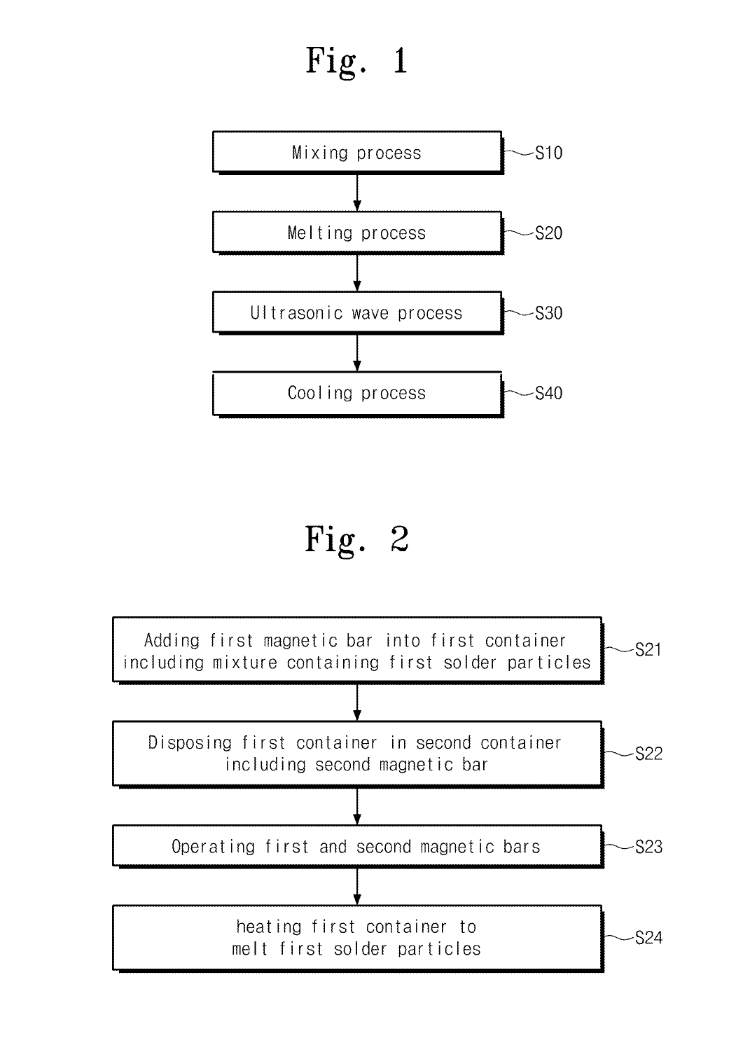

FIG. 1 is a flowchart illustrating a method of fabricating a solder particle according to an embodiment of the inventive concept. FIG. 2 is a flowchart illustrating a melting process according to an embodiment of the inventive concept.

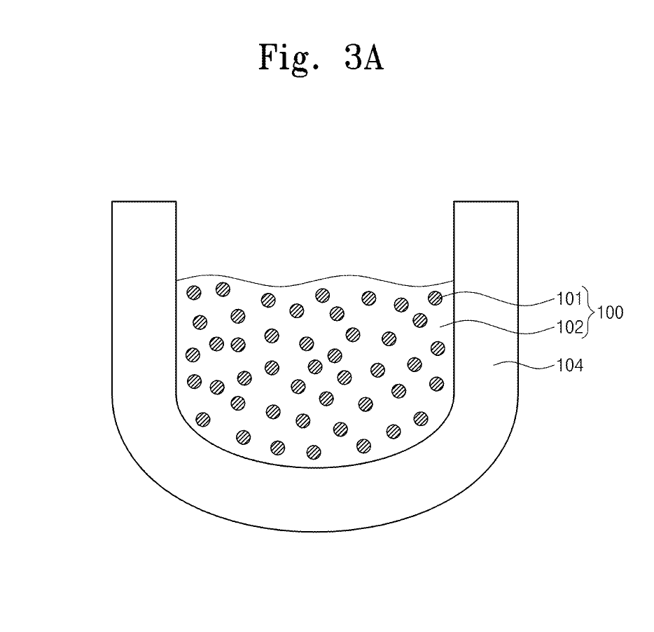

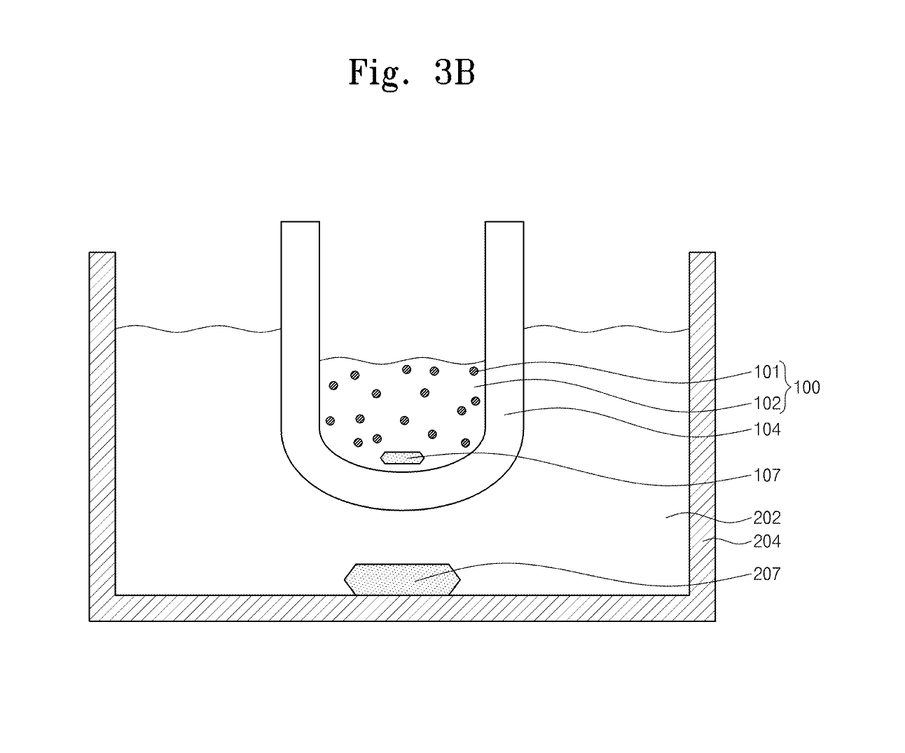

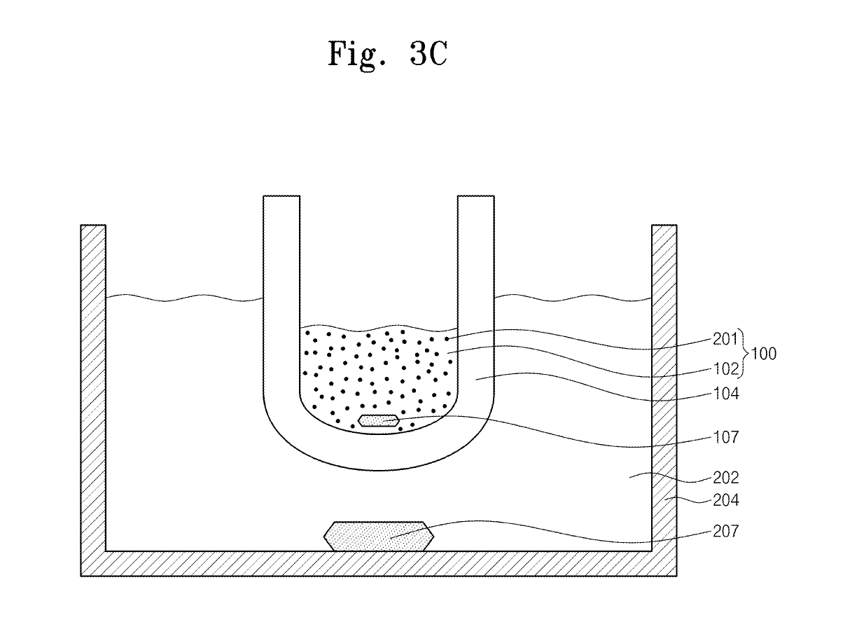

FIGS. 3A to 3C are cross-sectional views illustrating a method of fabricating a solder particle according to an embodiment of the inventive concept.

Referring to FIGS. 1 and 3A, a mixture 100 is obtained by mixing first solder particles 101 and a one-component polymer resin 102 (Step S10). The first solder particles 101 and the one-component polymer resin 102 may be mixed in a first container 104. Preferably, from about 1 to about 60 parts by volume of the first solder particles 101 based on about 100 parts by volume of the one-component polymer resin 102 are mixed. When the first solder particles 101 are mixed by about less than 1 parts by volume, dispersibility may be bad, and when the first solder particles 101 are mixed by more than about 60 parts by volume, viscosity may be excessively increased, and the formation of the solder particles having a uniform size may be difficult. The first solder particles 101 of a solid phase may be impregnated into the one-component polymer resin 102 of a liquid phase and may be isolated from the atmosphere.

The first solder particles 101 may have a diameter of from about 10 μm to about 1,000 μm. The first solder particles 101 may be an alloy of Sn, Bi, Ag, Cu, or Pb, and may include 60Sn/40Bi, 52In/48Sn, 97In/3Ag, 57Bi/42Sn/1Ag, 58Bi/32Pb/16Sn, 96.5Sn/3Ag/0.5Cu, and the like. The one-component polymer resin 102 may be an epoxy resin or oils. The epoxy resin may be a resin including diglycidyl ether of bisphenol-A (DGEBA), tetraglycidyl-4,4-diaminodiphenylmethane (TGDDM), diglycidyl ether of para-aminophenol (TriGDDM), or Isocyanate group, Bismaleimide resin, or the like. The oil may include, for example, epoxy modified silicone oil, amine modified silicone oil, carboxyl modified silicone oil, a polyol resin, and the like. The epoxy resin has better reactivity than the oils with a reducing agent, and is better for removing a solder oxide layer. Thus, the epoxy resin is preferred as the one-component polymer resin 102.

Preferably, the first container 104 may not be decomposed or corroded at a higher temperature than the melting point of the first solder particles 101. In addition, the first container 104 may have a round edge shape so that ultrasonic waves may be transferred to the first solder particles 101 in the one-component polymer resin 102 uniformly during conducting an ultrasonic wave process in a following process.

Referring to FIGS. 1 and 3B, heat is applied to the mixture 100 to melt the first solder particles 101 (Step S20). Referring to FIG. 2, the melting process includes adding a first magnetic bar 107 in the first container 104 (Step S21), disposing the first container 104 in a second container 204 including a second magnetic bar 207 (Step S22), operating the first and second magnetic bars 107 and 207 (Step S23), and applying heat to the first container 104 (Step S24). The first container 104 including the mixture 100 may be inserted into the second container 204 containing silicon oil 202, and the second container 204 may be heated to melt the first solder particles 101. The second container 204 may be heated by using, for example, a hot plate. By the heat applied to the second container 204, the temperature of the silicon oil 202 may be directly increased, and due to the temperature of the silicon oil 202, the first container 104 may be heated.

Alternatively, a heat wiring may be provided in the first container 104. In this case, the mixture 100 may be heated by itself without an external heating source.

The first and second magnetic bars 107 and 207 may be operated while applying the heat to the mixture 100 and the silicon oil 202 to maintain uniform temperature distribution of the mixture 100 and the silicon oil 202. For example, the first and second magnetic bars 107 and 207 may rotate in the first container 104 and the second container 204 by means of a magnetic stirrer. The first solder particles 101 may be melted at from about 80° C. to about 250° C.

Referring to FIGS. 1 and 3C, an ultrasonic wave process is conducted with respect to the mixture 100 to form second solder particles 201 having from about 0.1 μm to about 10 μm (Step S30). In the ultrasonic wave process, ultrasonic waves may be generated by disposing an ultrasonic wave apparatus (not illustrated) such as a vibrator in the first container 104. The ultrasonic wave process may be conducted by controlling ultrasonic wave frequency to about 10 kHz or above, ultrasonic wave operating number to about 1 or above, ultrasonic wave operating period to about 1 second or above, and ultrasonic wave vibration number. To form the second solder particles 201 having uniform diameters, the first and second magnetic bars 107 and 207 may be operated while conducting the ultrasonic wave process. Thus, the movement of the second solder particles 201 in the one-component polymer resin 102 may be induced.

The mixture 100 including the thus formed second solder particles 201 may be cooled (Step S40). The mixture may be cooled to room temperature (about 25° C.). During cooling the mixture 100, the second solder particles 201 may be exposed to the atmosphere, and an oxide layer at the surface of the second solder particles 201 may be increased. The second particles 201 may be coagulated. To prevent the above phenomena, the cooling process may be conducted while continuously operating the first and second magnetic bars 107 and 207. The mixture 100 may be cooled by providing an apparatus (not illustrated) for flowing a cooling medium along the outer portion of the second container 204.

According to an embodiment of the inventive concept, the coagulation of the first solder particles 101 may be prevented during melting the first solder particles 101 by using the first magnetic bar 107 and the second magnetic bar 207 in the melting process. In addition, by operating the first and second magnetic bars 107 and 207 during conducting the ultrasonic wave process and the cooling process, the second solder particles 201 having a uniform diameter of from about 0.1 μm to about 10 μm may be formed.

The mixture 100 including the second solder particles 201 after finishing the cooling process may be a paste state. The second solder particles 201 may form a micro bump or a solder on pad performing interconnection function by means of a screen printing, or the like. At least one compound among a reducing agent, a curing agent, and a catalyst may be added into the mixture 100. The processing time for adding the compound is not specifically limited. The reducing agent may be, for example, glutamic acid, malic acid, azelaic acid, abietic acid, adipic acid, ascorbic acid, acrylic acid or citric acid. The curing agent may be, for example, an amine-based curing agent (MPDA, DDM, DDS), an anhydride-based curing agent (MNA, DDSA, MA, SA, MTHPA, HHPA, PMDA), or the like. The catalyst may be, for example, BDMA, BF3-MEA, DMP-30, DMBA, or MI.

The mixture 100 may be formed having a high volume ratio of the solder particles with respect to the polymer resin by centrifugation method. In case of forming the mixture having the high volume ratio of the solder particles, the curing agent, the catalyst, or the reducing agent may be added. Therefore, the mixture having a target volume ratio may be obtained in a following process.

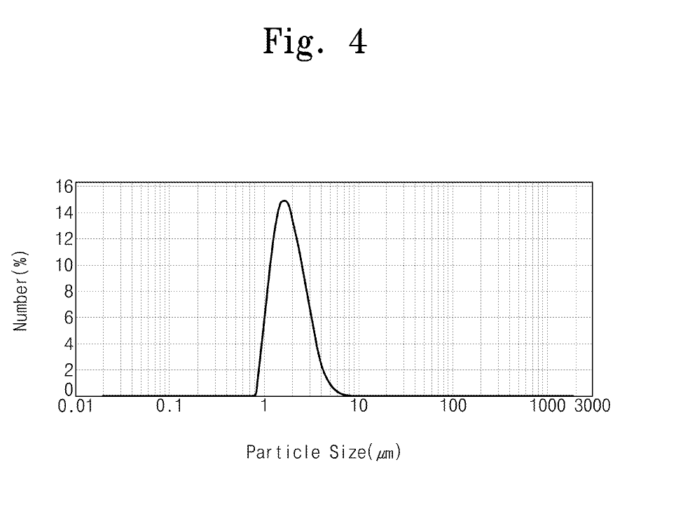

FIG. 4 is a graph illustrating the particle size of solder particles obtained by a method of fabricating a solder particle according to an embodiment of the inventive concept.

InSn was used as the solder particle, and the solder particle was fabricated by applying the conditions of the melting temperature of about 150° C., the ultrasonic wave frequency of about 10 kHz, the ultrasonic wave operating number of about 20 times, and the ultrasonic wave vibration number of about 200 or above. Then, the diameter of the thus obtained solder particle was measured. The diameter of the solder particles obtained by the method of fabricating a solder particle according to the inventive concept was confirmed to be in a range from about 1 μm to about 10 μm.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of fabricating a solder particle, the method comprising:
adding a first magnetic bar in a first container including a mixture containing first solder particles formed through a mixing process;
disposing the first container in a second container including a second magnetic bar;
operating the first magnetic bar and the second magnetic bar; and
applying heat to the first container to melt the first solder particles.

2. The method of fabricating a solder particle of claim 1, wherein the mixing process is conducted by mixing the first solder particles with a one-component polymer resin to obtain the mixture.

3. The method of fabricating a solder particle of claim 2, wherein the first solder particles are completely impregnated into the one-component polymer resin.

4. The method of fabricating a solder particle of claim 1, wherein silicon oil is included in the second container.

5. The method of fabricating a solder particle of claim 4, wherein the melting of the first solder particles is conducted by heating the silicon oil in the second container, thereby applying heat to the first container by a temperature of the silicon oil.

6. The method of fabricating a solder particle of claim 1, wherein a temperature of the mixture is maintained uniformly by the first magnetic bar and the second magnetic bar.

7. The method of fabricating a solder particle of claim 1, wherein the first solder particles are melted at from about 80° C. to about 250° C.

8. The method of fabricating a solder particle of claim 1, wherein the first solder particles have a diameter of from about 10 μm to about 1,000 μm.

9. The method of fabricating a solder particle of claim 2, wherein the one-component polymer resin comprises an epoxy resin or oil.

10. The method of fabricating a solder particle of claim 9, wherein the epoxy resin includes diglycidyl ether of bisphenol-A (DGEBA), tetraglycidyl-4,4-diaminodiphenylmethane (TGDDM), diglycidyl ether of para-aminophenol (TriGDDM), or Isocyanate group, or a Bismaleimide resin.

11. The method of fabricating a solder particle of claim 9, wherein the oil is epoxy modified silicone oil, amine modified silicone oil, carboxyl modified silicone oil, or a polyol resin.

12. The method of fabricating a solder particle of claim 2, wherein the first solder particles are mixed by from about 1 to about 60 parts by volume with respect to 100 parts by volume of the one-component polymer resin in the mixture.

13. The method of fabricating a solder particle of claim 1, wherein the first container has a round edge portion.

14. The method of fabricating a solder particle of claim 1, further comprising after melting the first solder particles:
conducting an ultrasonic wave process for forming second solder particles by applying ultrasonic wave to the mixture while operating the first magnetic bar and the second magnetic bar; and
conducting a cooling process for cooling the mixture including the second solder particles while operating the first magnetic bar and the second magnetic bar after conducting the ultrasonic wave process.

15. The method of fabricating a solder particle of claim 14, wherein the second solder particles has a diameter of from about 0.1 μm to less than about 10 μm.
